(19) United States
(12) Patent Application Publication
(10) Pub. No.: US 2026/0043523 A1
(43) Pub. Date: Feb. 12, 2026

(54) METHODS AND APPARATUS TO DETECT OBSTRUCTED VALVES IN PRESSURE RELIEF SYSTEMS

(71) Applicant: Emerson Automation Solution Final Control US LP, Houston, TX (US)

(72) Inventors: Marcelo Luis Dultra, Tomball, TX (US); Ricardo Jose Garcia, Katy, TX (US); William Brett Bockeloh, Houston, TX (US)

(21) Appl. No.: 18/800,913

(22) Filed: Aug. 12, 2024

(51) Int. Cl. F17C 13/02

(52) U.S. Cl. CPC F17C 13/025; F17C 13/028; F17C 2205/0332; F17C 2250/032; F17C 2250/0426; F17C 2250/0434; F17C 2260/038

(57) ABSTRACT

Systems, apparatus, articles of manufacture, and methods are disclosed to detect obstructed valves in pressure relief systems. An example pressure relief valve includes an inlet port to be selectively fluidly coupled to a pressure vessel via a first shutoff valve, an exhaust port fluidly coupled to the inlet port via a valve, the valve to fluidly couple the inlet port and the exhaust port while a fluid pressure within the inlet port exceeds a threshold value, a first pressure sensor to detect a fluid pressure within the inlet port, a second pressure sensor to detect a differential fluid pressure between the exhaust port and the inlet port, and a data transmitter to transmit pressure data associated with the fluid pressures detected by the pressure sensors to a computing device.

### FIELD OF THE DISCLOSURE

This disclosure relates generally to fluid valves and, more particularly, to methods and apparatus to detect obstructed valves in pressure relief systems.

### BACKGROUND

Pressure relief valves are typically used in pressurized fluid systems to maintain safe levels of fluid pressure. When the pressure inside the system passes a threshold level, the pressure relief valve opens to release fluid, thereby reducing pressure within the system. In some systems, pressure relief valves release fluid into the atmosphere, whereas in other systems, such as liquid natural gas systems, fluid is released into vessels specially designed to receive vented fluids. Pressure relief valves are often used in conjunction with isolation valves connected to both an inlet and an outlet of the pressure relief valve to control fluid flow through the pressure relief valve. The isolation valves are closed to prevent fluid flow within the pressure relief valve during service and inspection events.

### BRIEF DESCRIPTION OF THE DRAWINGS

FIG. 1 is a block diagram of an example fluid system in which an example controller operates to detect obstructed pressure relief valves.

FIG. 2 is a block diagram of an example implementation of the controller of FIG. 1.

FIGS. 3-6 are flowcharts representative of example machine readable instructions and/or example operations that may be executed, instantiated, and/or performed by example programmable circuitry to implement the controller of FIG. 2.

FIG. 7 is a block diagram of an example processing platform including programmable circuitry structured to execute, instantiate, and/or perform the example machine readable instructions and/or perform the example operations of FIGS. 3, 4, 5, and/or 6 to implement the controller of FIG. 2.

In general, the same reference numbers will be used throughout the drawing(s) and accompanying written description to refer to the same or like parts. The figures are not necessarily to scale.

### DETAILED DESCRIPTION

In many industries, such as the natural gas industry, isolation valves are placed at an inlet and an outlet of a pressure relief valve (PRV) in fluid systems. When the PRV is serviced, the isolation valves are closed to isolate the PRV from the fluid system. This allows the PRV to be inspected, serviced, and/or removed. When service is complete, the isolation valves are opened again to reconnect the PRV to the fluid system. However, if the isolations valves are not properly reopened, the PRV may not function as intended. An obstructed PRV, such as a PRV with an isolation valve that is not fully opened, may not properly relieve a vessel that is over pressurized.

Example apparatus and methods described herein detect an obstructed PRV by determining the status of an isolation valve or valves connected to the PRV. In this way, isolation valves that are closed, partially closed, or otherwise obstructed can be detected quickly and restored to a fully open position. Example apparatus and methods described herein can easily be installed across a PRV without the need for extra piping modifications that increase costs or create inlet piping losses to the overpressure protection system. Example apparatus and methods described herein can monitor pressure relief events within a PRV to estimate a total volume of fluid moving through the PRV during a pressure relief event or to identify leaks within the PRV.

Example apparatus and methods described herein include a fluid system comprising a vessel to contain a fluid, a pressure relief valve coupled to the vessel via a first isolation valve, and a computing device. Pressure sensors are located in the fluid system to measure pressure in the vessel, pressure in an inlet of the pressure relief valve, and pressure in an outlet of the pressure relief valve. The computing device receives pressure data associated with the measured pressures to determine a state of the first isolation valve and generate an indication corresponding to the state of the first isolation valve.

Example apparatus and methods described herein include a pressure relief valve having an inlet port to be selectively fluidly coupled to a pressure vessel via a first shutoff valve, an exhaust port fluidly coupled to the inlet port via a valve, the valve to fluidly couple the inlet port and the exhaust port while a fluid pressure within the inlet port exceeds a threshold value, a first pressure sensor to detect a fluid pressure within the inlet port, a second pressure sensor to detect a differential fluid pressure between the exhaust port and the inlet port, and a data transmitter to transmit pressure data associated with the fluid pressures detected by the pressure sensors to a computing device.

Example apparatus and methods described herein include a non-transitory machine readable storage medium comprising instructions to cause programmable circuitry to at least obtain first pressure data from a vessel, obtain second pressure data from an inlet of a pressure relief valve, the pressure relief valve coupled to the vessel via a first isolation valve such that fluid flows from the vessel to the pressure relief valve when the first isolation valve is in an open position, obtain third pressure data from an outlet of the pressure relief valve, and determine a state of the first isolation valve based on the pressure data.

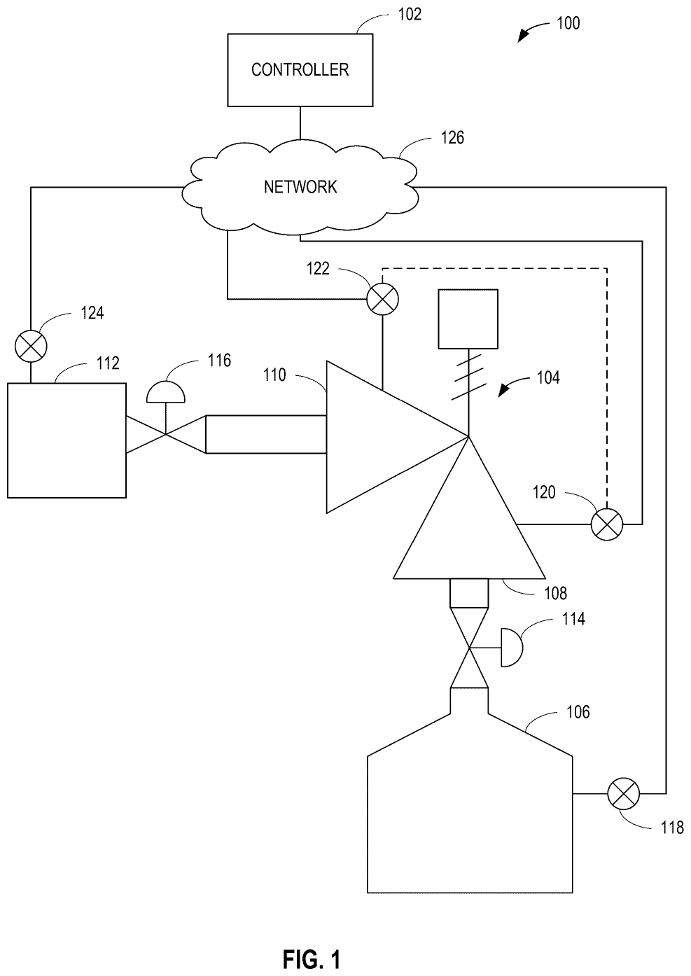

FIG. 1 is a block diagram of an example fluid system 100 in which an example controller 102 operates to detect obstructed pressure relief valves. An example pressure relief valve (PRV) 104 is coupled to an example fluid vessel 106 (e.g., pressure vessel). The fluid vessel 106 contains one or more fluids (e.g., pressurized gases, pressurized liquids, etc.) that experience changing pressures. The PRV 104 includes an example inlet 108 (e.g., inlet port, intake port, etc.) and an example outlet 110 (e.g., outlet port, exhaust port, etc.). When a fluid pressure within inlet 108 exceeds a threshold value (e.g., a set pressure), the PRV 104 opens to connect (e.g., fluidly couple, selectively fluidly couple, etc.) the inlet 108 to the outlet 110. In this way, fluid flows from the inlet 108 to the outlet 110 to lower the fluid pressure in the inlet 108. When the fluid pressure in the inlet 108 falls below the threshold value (e.g., set pressure), the PRV 104 closes to disconnect (e.g., fluidly decouple, selectively fluidly decouple) the inlet 108 from the outlet 110. In other words, the PRV 104 selectively fluidly couples the inlet 108 and the outlet 110 based on a comparison of the fluid pressure in the inlet 108 to the threshold pressure value. Thus, when the fluid vessel 106 is fluidly coupled to the PRV 104 via the inlet 108, the fluid pressure within the fluid vessel 106 is relieved (e.g., regulated to a threshold pressure or below) via the PRV 104. In some examples, the PRV 104 opens when the fluid pressure in the inlet 108 is approximately equal to threshold value (e.g., within 3% of the threshold value). The outlet 110 of the PRV 104 is coupled to an example secondary vessel 112 (e.g., a relief header). In other examples, the outlet 110 of the PRV 104 exhausts fluid directly to atmosphere (e.g., the local environment) and is not further coupled to another vessel.

FIG. 1 includes an example first isolation valve 114 coupling the vessel 106 to the PRV 104 and an example second isolation valve 116 coupling the PRV 104 to the secondary vessel 112. The first isolation valve 114 (e.g., shutoff valve) fluidly couples and fluidly decouples (e.g., selectively fluidly couples) the vessel 106 to the PRV 104. Similarly, the second isolation valve 116 (e.g., shutoff valve) fluidly couples and fluidly decouples the PRV 104 from the secondary vessel 112. For example, the first isolation valve 114 and/or the second isolation valve 116 moves (e.g., rotates) from an open position that allows fluid to flow through freely to a closed position that prevents fluid from flowing. In some examples, the first isolation valve 114 and/or the second isolation valve 116 moves to an intermediate position (e.g., half closed position, partially closed position) causing the flow of fluid to be obstructed or otherwise slowed. Obstructed fluid flow into and/or out of the PRV 104 can lead to malfunction of the PRV 104. Thus, the controller 102 monitors the PRV 104 to detect a status of the isolation valves 114, 116.

The controller 102 of FIG. 1 receives pressure data from an example vessel pressure sensor 118, an example inlet pressure sensor 120, an example outlet pressure sensor 122, and an example relief header pressure sensor 124. The vessel pressure sensor 118 obtains fluid pressure data from within the fluid vessel 106 (e.g., vessel pressure data). The inlet pressure sensor 120 obtains fluid pressure data from within the inlet 108 (e.g., inlet pressure data). In some examples, the inlet pressure sensor 120 is disposed in a housing exterior to the inlet 108 and is fluidly coupled to the inlet 108 via a pipe. In other examples, the inlet pressure sensor 120 obtains fluid pressure data from piping between the inlet 108 and the first isolation valve 114. The outlet pressure sensor 122 obtains fluid pressure data from within the outlet 110 (e.g., outlet pressure data). In some examples, the outlet pressure sensor 122 is disposed in a housing exterior to the outlet 110 and is fluidly coupled to the outlet 110 via a pipe. In other examples, the outlet pressure sensor 122 obtains fluid pressure data from piping between the outlet 110 and the second isolation valve 116. In some examples, the inlet pressure sensor 120 and the outlet pressure sensor 122 are paired, and the outlet pressure sensor 122 obtains a differential fluid pressure (e.g., a difference in pressure) between the inlet 108 and the outlet 110. The relief header pressure sensor 124 obtains fluid pressure data from within the secondary fluid vessel 112 (e.g., relief header pressure data). In some examples the outlet 110 vents fluid to the atmosphere, instead of the secondary fluid vessel 112, and the fluid system 100 does not include a relief header pressure sensor 124.

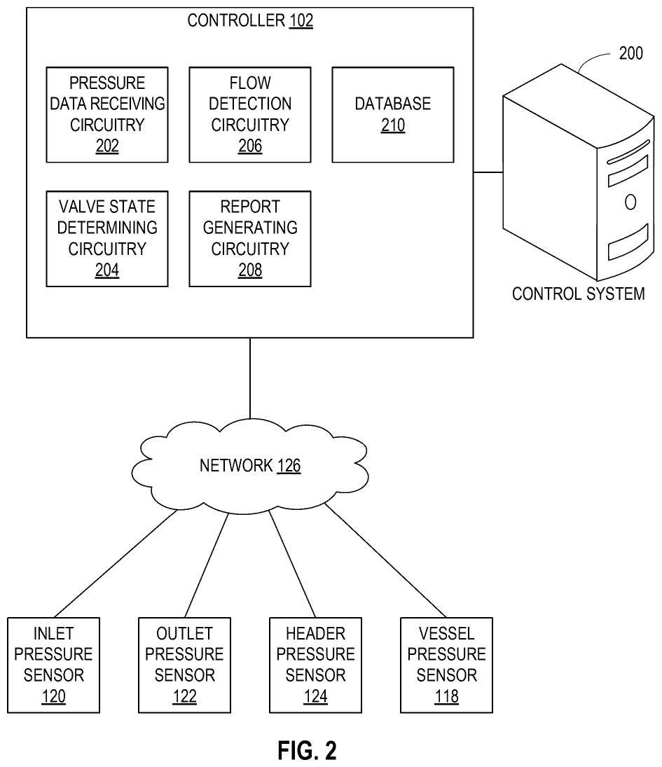

The vessel pressure sensor 118, the inlet pressure sensor 120, the outlet pressure sensor 122, and the relief header pressure sensor 124 of FIG. 1 are in communication with an example network 126. The controller 102 receives the vessel pressure data from the vessel pressure sensor 118, the inlet pressure data from the inlet pressure sensor 120, the outlet pressure data from the outlet pressure sensor 122, and/or the relief header pressure data from the relief header pressure sensor 124 via the network 126. In some examples, the vessel pressure sensor 118, the inlet pressure sensor 120, the outlet pressure sensor 122, and the relief header pressure sensor 124 communicate to the network 126 via a data transmitter using wireless communication. As described in more detail in relation to FIG. 2 below, the controller 102 compares measured pressures from the first pressure data, the second pressure data, the third pressure data, and/or the fourth pressure data to determine the state of the first isolation valve 114 and/or the second isolation valve 116.

FIG. 2 is a block diagram of an example implementation of the controller 102 of FIG. 1 to detect obstructed pressure relief valves. The controller 102 (e.g., computing device) of FIG. 2 may be instantiated (e.g., creating an instance of, bring into being for any length of time, materialize, implement, etc.) by programmable circuitry such as a Central Processor Unit (CPU) executing first instructions. Additionally or alternatively, the controller 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware.

Moreover, in some examples, some or all of the circuitry of FIG. 2 may be implemented by microprocessor circuitry executing instructions and/or FPGA circuitry performing operations to implement one or more virtual machines and/or containers.

The controller 102 of FIG. 2 determines the state of one or more isolation valves based on pressure data received from pressure sensors in a fluid system. The controller 102 communicates with an example control system 200. The control system 200 controls a broader fluid system including a pressure relief valve (e.g., the PRV 104 of FIG. 1) connected to one or more isolation valves (e.g., the first and second isolation valves 114, 116 of FIG. 1). The control system 200 includes a user interface to present reports and alerts generated by the controller 102 to a user. In some examples, some or all of the circuitry of FIG. 2 may be instantiated as part of the control system 200.

The controller 102 of FIG. 2 includes example pressure data receiving circuitry 202, example valve state determining circuitry 204, example flow detection circuitry 206, example report generating circuitry 208, and an example database 210.

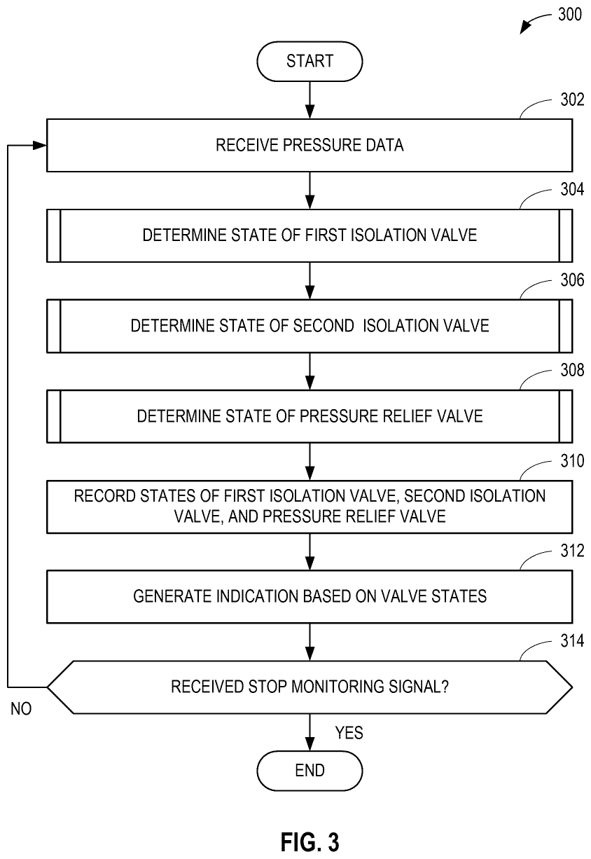

The pressure data receiving circuitry 202 receives pressure data from pressure sensors such as the vessel pressure sensor 118, the inlet pressure sensor 120, the outlet pressure sensor 122, and/or the relief header pressure sensor 124 of FIG. 1. In some examples, the pressure data receiving circuitry 202 converts raw data (e.g., sensor voltages, sensor currents, etc.) into pressure values (e.g., pounds per square inch, pascals, atmospheres, etc.) after receiving the measured pressure data. The pressure data receiving circuitry 202 correlates pressure sensors with various locations (e.g., inlet pressure, outlet pressure, fluid vessel pressure, relief header pressure, etc.). The pressure data receiving circuitry 202 stores time correlated pressure data in the database 210. In this way, the pressure data receiving circuitry 202 can calculate pressure changes over time and pressure change rates (e.g., how quickly pressure values change). Calculated pressure change rates are stored in the database 210 for later use. For example, valve state determining circuitry 204 compares the pressure change rates of the vessel pressure sensor (e.g., the vessel pressure sensor 118) to the pressure change rates of the inlet pressure sensor (e.g., the inlet pressure sensor 120) to determine a state of an isolation valve between them. In some examples, the pressure data receiving circuitry 202 is instantiated by programmable circuitry executing pressure data receiving instructions and/or configured to perform operations such as those represented by the flowchart of FIG. 3.

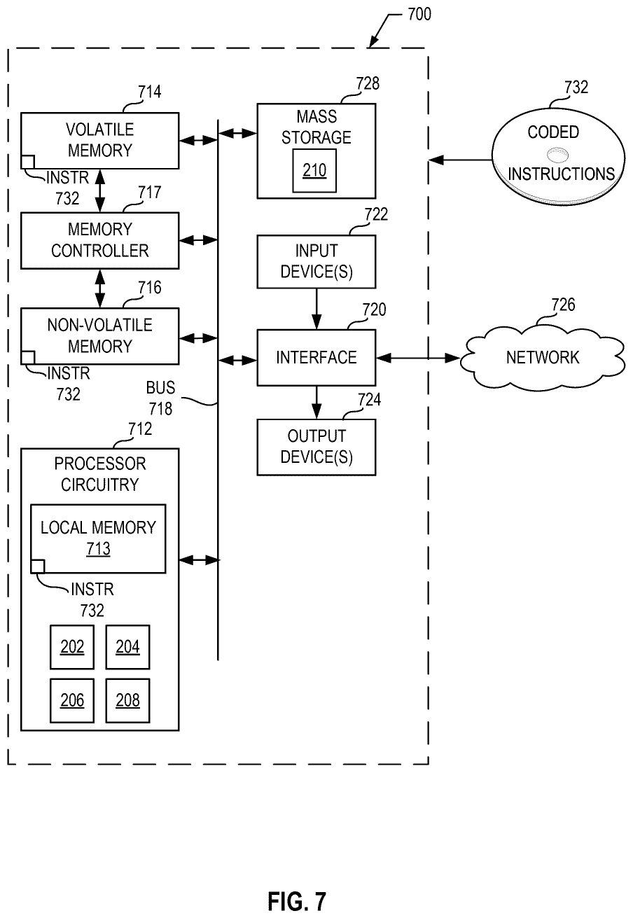

In some examples, the controller 102 includes means for receiving pressure data. For example, the means for receiving may be implemented by pressure data receiving circuitry 202. In some examples, the pressure data receiving circuitry 202 may be instantiated by programmable circuitry such as the example programmable circuitry 712 of FIG. 7. For instance, the pressure data receiving circuitry 202 may be instantiated by a microprocessor executing machine executable instructions such as those implemented by at least blocks 302 of FIG. 3. In some examples, pressure data receiving circuitry 202 may be instantiated by hardware logic circuitry, which may be implemented by an ASIC, XPU, or FPGA circuitry configured and/or structured to perform operations corresponding to the machine readable instructions. Additionally or alternatively, the pressure data receiving circuitry 202 may be instantiated by any other combination of hardware, software, and/or firmware. For example, the pressure data receiving circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

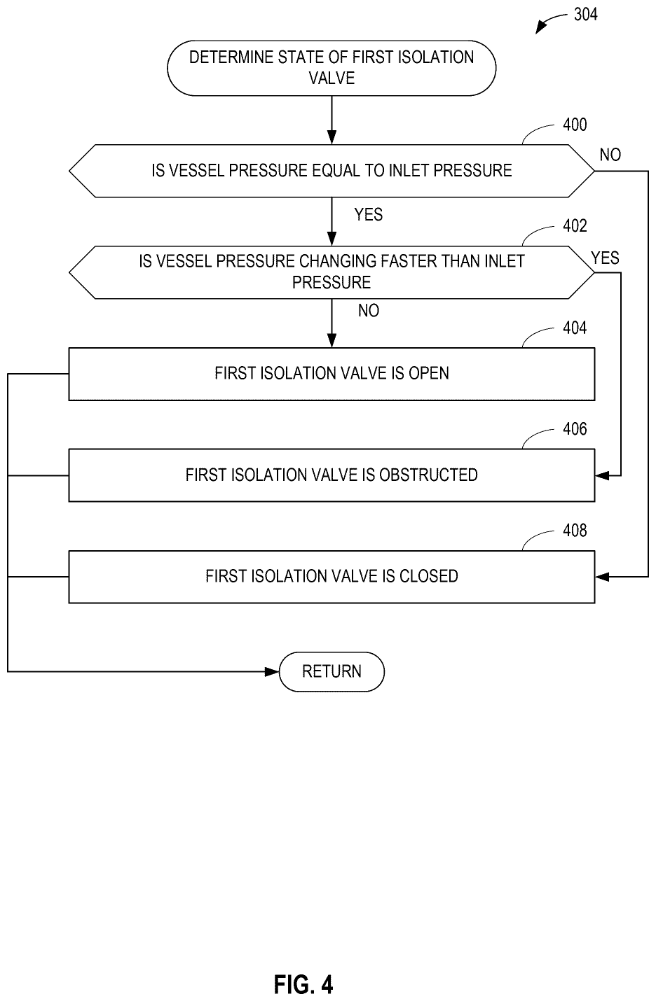

The valve state determining circuitry 204 of FIG. 2 determines a state of an isolation valve (e.g., shutoff valve) near a PRV based on fluid pressures around the isolation valve. The valve state determining circuitry 204 receives pressure data from the pressure data receiving circuitry 202 and/or the database 210. The valve state determining circuitry 204 compares pressure data generated by pressure sensors before and after the isolation valve (e.g., upstream of the isolation valve and downstream of the isolation valve). Pressure data that is approximately equal (e.g., within 3%) before and after the isolation valve indicates that the isolation valve is not in a closed (e.g., blocked) state. The valve state determining circuitry 204 further observes fluctuations in the pressure reading before and after the isolation valve to determine if the rate of change of pressure is approximately equal (e.g., within 3%), which indicates that the isolation valve is in a fully open state. If the valve state determining circuitry 204 determines that the rate of change of pressure before and after the isolation valve is not approximately equal, the valve state determining circuitry 204 determines that the isolation valve is in a blocked or obstructed (e.g., restricted, partially closed, etc.) state. In examples where multiple isolation valves are present (e.g., a first isolation valve before the PRV and a second isolation valve after the PRV), the valve state determining circuitry 204 can compare pressure data from more than two pressure sensors to determine a state of one or more of the isolation valves. In some examples, the valve state determining circuitry 204 is instantiated by programmable circuitry executing valve state determining instructions and/or configured to perform operations such as those represented by the flowcharts of FIGS. 3, 4, and/or 5.

In some examples, the controller 102 includes means for determining a valve state. For example, the means for determining may be implemented by valve state determining circuitry 204. In some examples, the valve state determining circuitry 204 may be instantiated by programmable circuitry such as the example programmable circuitry 712 of FIG. 7. For instance, the valve state determining circuitry 204 may be instantiated by a microprocessor executing machine executable instructions such as those implemented by at least blocks 304, 306, 400, 402, 404, 406, 408, 500, 502, 504, 506, 508, 510, 512, 514 of FIGS. 3-5. In some examples, valve state determining circuitry 204 may be instantiated by hardware logic circuitry, which may be implemented by an ASIC, XPU, or FPGA circuitry configured and/or structured to perform operations corresponding to the machine readable instructions. Additionally or alternatively, the valve state determining circuitry 204 may be instantiated by any other combination of hardware, software, and/or firmware. For example, the valve state determining circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example flow detection circuitry 206 of FIG. 2 monitors the pressure data collected around a PRV (e.g., pressure at the inlet 108 and the outlet 110 of FIG. 1) to determine if fluid is flowing through the PRV (e.g., the PRV 104 of FIG. 1). Fluid flow through the PRV can be a result of a pressure relief event (e.g., the pressure within the inlet 108 exceeding a threshold value). Alternatively, the fluid flow through the PRV can be a result of a leak within the PRV (e.g., a leak at the valve seat, etc.). By monitoring the relative pressures (e.g., differential pressure) of the inlet and the outlet, the flow detection circuitry 206 determines when fluid begins flowing from the inlet to the outlet. In some examples, the flow detection circuitry 206 estimates the amount of fluid (e.g., total volume of fluid) that flows through the PRV during a pressure relief event. In some examples, the flow detection circuitry 206 determines a state of the PRV (e.g., blocked, obstructed, restricted, unblocked, open, etc.) based on the pressure data around the PRV. In some examples, the flow detection circuitry 206 is instantiated by programmable circuitry executing PRV state determining instructions and/or configured to perform operations such as those represented by the flowcharts of FIGS. 3 and/or 6.

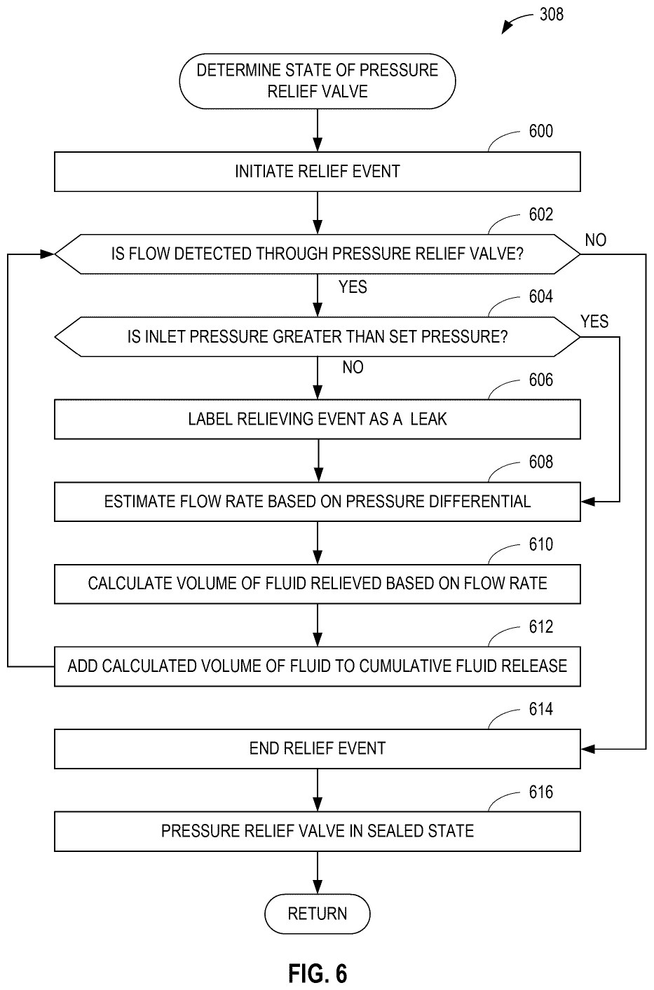

In some examples, the controller 102 includes means for determining a PRV state. For example, the means for determining may be implemented by flow detection circuitry 206. In some examples, the flow detection circuitry 206 may be instantiated by programmable circuitry such as the example programmable circuitry 712 of FIG. 7. For instance, the flow detection circuitry 206 may be instantiated by a microprocessor executing machine executable instructions such as those implemented by at least blocks 308, 600, 602, 604, 606, 608, 610, 612, 614, 616 of FIGS. 3 and 6. In some examples, flow detection circuitry 206 may be instantiated by hardware logic circuitry, which may be implemented by an ASIC, XPU, or FPGA circuitry configured and/or structured to perform operations corresponding to the machine readable instructions. Additionally or alternatively, the flow detection circuitry 206 may be instantiated by any other combination of hardware, software, and/or firmware. For example, the flow detection circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example report generating circuitry 208 of FIG. 2 generates reports and/or alerts regarding the status of the PRV and associated isolation valves. In some examples, the reports and/or alerts are sent to the control system 200 to be used in control processes. In some examples, the reports and/or alerts are received by a user device in communication with the controller 102 and/or the control system 200 and presented to a user. The reports generated by the report generating circuitry 208 include detected states (e.g., open, obstructed, closed, undetermined, etc.) of one or more isolation valves associated with the PRV. Additionally or alternatively, the reports generated by the report generating circuitry 208 include pressure data associated with one or more pressure sensors along a flow path through the PRV. In some examples, the reports generated by the report generating circuitry 208 include data regarding fluid flow through the PRV (e.g., presence of a pressure relief event, estimated volume flowing through the PRV, etc.) generated by the flow detection circuitry 206. In some examples, the alerts generated by the report generating circuitry 208 include a warning regarding potentially unsafe or otherwise undesired conditions around the PRV. For example, the alerts can inform the user that PRV is obstructed or otherwise inoperable. In other examples, the alerts can inform the user that an isolation valve is not in the open position. The alerts can also include descriptions of sensor data that is out of an expected range, such as pressure readings outside of a measurement range of a pressure sensor or outlet pressure readings of a PRV being higher than inlet pressure readings of the PRV. In some examples, the report generating circuitry 208 is instantiated by programmable circuitry executing report generating instructions and/or configured to perform operations such as those represented by the flowcharts of FIGS. 3, 4, 5, and/or 6.

In some examples, the controller 102 includes means for generating a report. For example, the means for generating may be implemented by report generating circuitry 208. In some examples, the report generating circuitry 208 may be instantiated by programmable circuitry such as the example programmable circuitry 712 of FIG. 7. For instance, the report generating circuitry 208 may be instantiated by a microprocessor executing machine executable instructions such as those implemented by at least blocks 310, 312, 404, 406, 408, 508, 510, 512, 514, 606, and 616 of FIGS. 3-6. In some examples, report generating circuitry 208 may be instantiated by hardware logic circuitry, which may be implemented by an ASIC, XPU, or FPGA circuitry configured and/or structured to perform operations corresponding to the machine readable instructions. Additionally or alternatively, the report generating circuitry 208 may be instantiated by any other combination of hardware, software, and/or firmware. For example, the report generating circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the controller 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example pressure data receiving circuitry 202, the example valve state determining circuitry 204, the example flow detection circuitry 206, the example report generating circuitry 208, the example database 210 and/or, more generally, the example controller 102 of FIG. 2, may be implemented by hardware alone or by hardware in combination with software and/or firmware. Thus, for example, any of the example pressure data receiving circuitry 202, the example valve state determining circuitry 204, the example flow detection circuitry 206, the example report generating circuitry 208, the example database 210, and/or, more generally, the example controller 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example controller 102 of FIG. 2 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed by programmable circuitry to implement and/or instantiate the controller 102 of FIG. 2 and/or representative of example operations which may be performed by programmable circuitry to implement and/or instantiate the controller 102 of FIG. 2, are shown in FIGS. 3, 4, 5, and/or 6. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA). In some examples, the machine readable instructions cause an operation, a task, etc., to be carried out and/or performed in an automated manner in the real world. As used herein, “automated”means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3, 4, 5, and/or 6, many other methods of implementing the example controller 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 3, 4, 5, and/or 6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

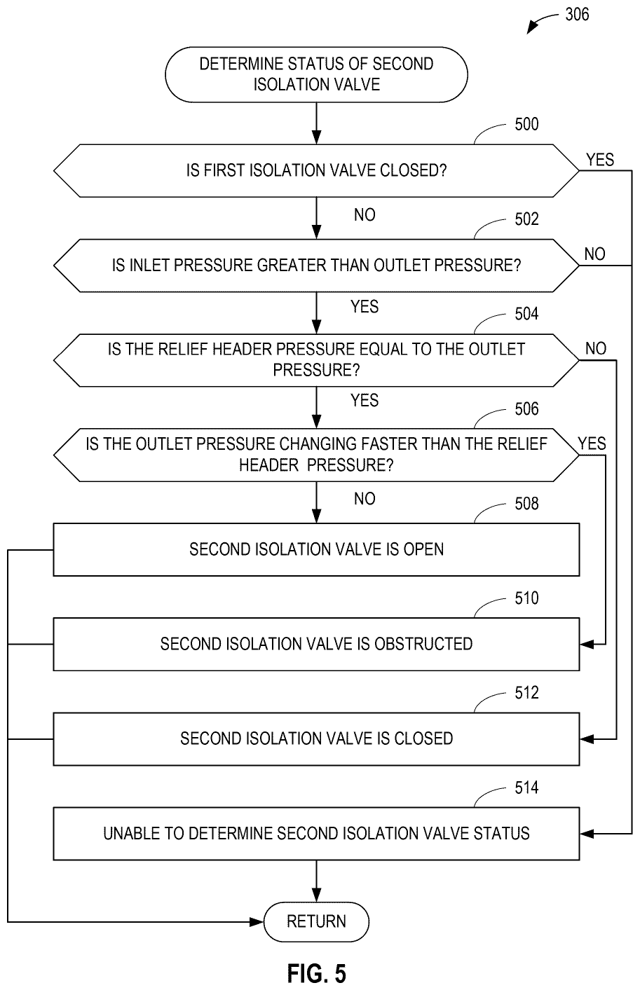

FIG. 3 is a flowchart representative of example machine readable instructions and/or example operations 300 that may be executed, instantiated, and/or performed by programmable circuitry to detect an obstructed pressure relief valve. The example machine-readable instructions and/or the example operations 300 of FIG. 3 begin at block 302, at which the pressure data receiving circuitry 202 receives pressure data generated by pressure sensors (e.g., the vessel pressure sensor 118, the inlet pressure sensor 120, the outlet pressure sensor 122, the relief header pressure sensor 124, etc.) positioned along a fluid flow path that includes a pressure relief valve. The pressure sensors at least measure pressure across valves (e.g., the first isolation valve 114, the second isolation valve 116, the PRV 104) within the fluid flow path. The operations 300 continue to block 304, as further detailed below in relation to FIG. 4, where the valve state determining circuitry 204 determines a state (e.g., obstructed, opened, closed, etc.) of a first isolation valve upstream of the PRV (e.g., the first isolation valve 114) based on the received pressure data. The operations 300 continue to block 306, as further detailed below in relation to FIG. 5, where the valve state determining circuitry 204 determines the state (e.g., obstructed, opened, closed, undetermined, etc.) of a second isolation valve downstream of the PRV (e.g., the second isolation valve 116) based on the received pressure data. The operations 300 continue to block 308, as further detailed below in relation to FIG. 6, where the flow detection circuitry 206 determines the state of the PRV (e.g., the PRV 104) based on the received pressure data. The operations 300 continue to block 310, where the report generating circuitry 208 records state data corresponding to the first isolation valve, the second isolation valve, and the PRV in the database 210. The operations 300 continue to block 312, where the report generating circuitry 208 generates an indication based on valve states. In some examples, the indication includes a listing of valves and their states. In other examples, the indication includes a visual representation of the first isolation valve, the PRV, and the second isolation valve that reflects the states of the valves. In some examples, the indication includes a warning or alert corresponding to closed isolation valves, a leak in the PRV, and/or unexpected pressure levels. The operations continue to block 314, where the controller 102 determines if a signal has been received to stop monitoring the PRV. If no signal has been received, the operations 300 return to block 302. If a signal to stop monitoring has been received, the operations 300 end.

FIG. 4 is a flowchart representative of example machine readable instructions and/or example operations 304 that may be executed, instantiated, and/or performed by programmable circuitry to determine a state of a first isolation valve (e.g., an isolation valve upstream of the PRV). The example machine readable instructions and/or example operations 304 of FIG. 4 begin at block 400, where the valve state determining circuitry 204 compares current pressure data corresponding to the vessel to current pressure data corresponding to the inlet. If the inlet pressure is not approximately equal to (e.g., within 3%) the vessel pressure, the operations 304 move to block 408. In some examples, the valve state determining circuitry 204 compares the vessel pressure to the inlet pressure after a configurable time delay to allow pressures to stabilize before comparison. At block 408, the first isolation valve is assigned a state of closed by the valve determining circuitry 204 and the report generating circuitry 208, and the operations 304 return to the operations 300 of FIG. 3. A closed first isolation valve fluidly decouples the vessel from the inlet of the PRV. As such, the pressure is not allowed to equalize between the vessel and the inlet, leading to the pressure data received from the vessel to not match the pressure data received from the inlet. Returning to block 400 of FIG. 4, if the vessel pressure is approximately equal (e.g., within 3%) to the inlet pressure, the operations 304 move to block 402. At block 402, the valve state determining circuitry 204 determines if vessel pressure is changing faster than inlet pressure. In other words, the valve state determining circuitry 204 reviews historic pressure data corresponding to the vessel pressure and the inlet pressure in the database 210 to compare the rate of pressure change in the vessel with the rate of pressure change in the inlet. If the pressure in the vessel is changing faster than the pressure in the inlet, the operations 304 move to block 406. At block 406, the first isolation valve is assigned a state of obstructed by the valve determining circuitry 204 and the report generating circuitry 208, and the operations 304 return to the operations 300 of FIG. 3. The obstructed state indicates that the vessel and inlet are fluidly coupled, but fluid does not freely move between the vessel and the inlet. In other words, if the isolation valve is obstructed or otherwise restricted, changes in pressure within the inlet will lag changes in pressure of the vessels as fluid is slow to enter the inlet and equalize the pressure. In some examples, the valve state determining circuitry 204 compares the rate of pressure change between the vessel and the inlet to determine if the rates of pressure change are beyond a threshold of similarity (e.g., pressure equalizes within a threshold time, pressure change rates are within 3%). Returning to block 402 of FIG. 4, if the pressure in the vessel is changing at an equal rate (e.g., within a threshold of 3% similarity) compared to the pressure in the inlet, the operations 304 continue to block 404. At block 404, the first isolation valve is assigned the state of open by the valve state determining circuitry and the report generating circuitry 208, and the operations 304 return to the operations 300 of FIG. 3. The open state indicates that fluid is freely flowing between the vessel and the inlet.

FIG. 5 is a flowchart representative of example machine readable instructions and/or example operations 306 that may be executed, instantiated, and/or performed by programmable circuitry to determine a state of a second isolation valve. The operations 306 begin at block 500, where the valve state determining circuitry 204 determines if the first isolation valve (e.g., the first isolation valve 114) is closed. The valve state determining circuitry 204 determines if a state of closed has been assigned to the first isolation valve during the operations 304 of FIG. 4. If the first isolation valve is in the closed state, the operations 306 of FIG. 5 continue to block 514 where the valve state determining circuitry 204 is unable to determine a status of the second isolation valve. If the first isolation valve is in a closed state, fluid is prevented from flowing through the PRV and pressure readings cannot be correlated to a state of the second isolation valve. Therefore, the second isolation valve is assigned an undetermined state by the valve state determining circuitry 204 and the report generating circuitry 208 to reflect this uncertainty, and the operations 306 return to the operations 300 of FIG. 3.

Returning to block 500 of FIG. 5, if the first isolation valve is not in a closed state, the operations 306 continue to block 502 where the valve state determining circuitry 204 determines if the inlet pressure is greater than the outlet pressure. The valve state determining circuitry 204 compares the current pressure data corresponding to the inlet pressure sensor (e.g., the inlet pressure sensor 120) to the current pressure data corresponding to the outlet pressure sensor (e.g., the outlet pressure sensor 122). In some examples, the valve state determining circuitry 204 compares the inlet pressure to the outlet pressure after a configurable time delay to allow pressures to stabilize before comparison. If the inlet pressure is not greater than the outlet pressure (e.g., the inlet pressure is less than 97% of the outlet pressure), the operations 306 continue to block 514 where the valve state determining circuitry 204 is unable to determine a status of the second isolation valve. As the PRV is designed to release higher pressure fluid from the inlet to a lower pressure outlet, a PRV with a higher pressure outlet than the inlet indicates a malfunction of the PRV or the pressure sensors of the inlet and/or the outlet. Therefore, the second isolation valve is assigned an undetermined state by the valve state determining circuitry 204 and the report generating circuitry 208 to reflect this malfunction, and the operations 306 return to the operations 300 of FIG. 3.

Returning to block 502 of FIG. 5, if the inlet pressure is greater than the outlet pressure, the operations 306 continue to block 504. At block 504, the valve state determining circuitry 204 determines if the relief header pressure is approximately equal to (e.g., within 3% of) the outlet pressure. The valve state determining circuitry 204 compares the current pressure data corresponding to the outlet pressure sensor (e.g., the outlet pressure sensor 122) to the current pressure data corresponding to the relief header pressure sensor (e.g., the relief header pressure sensor 124). In some examples, the valve state determining circuitry 204 compares the outlet pressure to the relief header pressure after a configurable time delay to allow pressures to stabilize before comparison. If the relief header pressure is not equal to the outlet pressure, indicating that the relief header is not fluidly coupled to the outlet, the operations 306 move to block 512 where the second isolation valve is assigned a state of closed by the valve state determining circuitry 204 and the report generating circuitry 208, and the operations 306 return to the operations 300 of FIG. 3. A closed second isolation valve fluidly decouples the outlet of the PRV from the relief header. As such, the pressure is not allowed to equalize between the outlet and the relief header, leading to the pressure data received from the outlet to not match the pressure data received from the relief header. Returning to block 504 of FIG. 5, if the relief header pressure is equal to the outlet pressure, the operations 306 continue to block 506.

At block 506 of the operations 306 of FIG. 5, the valve state determining circuitry 204 determines if the outlet pressure is changing faster than the relief header pressure. In other words, the valve state determining circuitry 204 reviews historic pressure data corresponding to the outlet pressure and the relief header pressure in the database 210 to compare the rate of pressure change in the outlet with the rate of pressure change in the relief header. If the pressure in the outlet is changing faster than the pressure in the relief header, the operations 306 continue to block 510. At block 510, the second isolation valve is assigned the state of obstructed by the valve state determining circuitry 204 and the report generating circuitry 208, and the operations 306 return to the operations 300 of FIG. 3. The obstructed state indicates that the outlet and relief header are fluidly coupled, but fluid does not freely move between the outlet and the relief header. In other words, if the second isolation valve is obstructed or otherwise restricted, changes in pressure within the relief header will lag changes in pressure of the outlet as fluid is slower to enter the relief header and equalize the pressure. In some examples, the valve state determining circuitry 204 compares the rate of pressure change between the outlet and the relief header to determine if the rates of pressure change are within a threshold of similarity (e.g., pressure equalizes within a threshold time, pressure change rates are within 3%).

Returning to block 506 of FIG. 5, if the pressure in the outlet is not changing faster than (e.g., within a threshold of 3% similarity) the pressure in the relief header, the operations 306 continue to block 508. At block 508, the second isolation valve is assigned the state of open by the valve state determining circuitry 204 and the report generating circuitry 208, and the operations 306 return to the operations 300 of FIG. 3. The open state indicates that fluid is freely flowing between the outlet and the relief header.

FIG. 6 is a flowchart representative of example machine readable instructions and/or example operations 308 that may be executed, instantiated, and/or performed by programmable circuitry to determine a state of a pressure relief valve (PRV). The operations 308 begin at block 600, where the flow detection circuitry 206 initiates a relief event. The relief event represents a period of time where fluid flow is detected between the inlet and the outlet of the PRV. The relief event includes data corresponding to when the relief event occurred, an amount of time the fluid was flowing during the relief event, and an amount fluid that moved between the inlet and the outlet during the relief event. By initiating the relief event, the flow detection circuitry 206 starts a new relief event to which time and pressure data can be correlated. The operations 308 continue to block 602, where the flow detection circuitry 206 determines if fluid flow is detected through the PRV. In some examples, the flow detection circuitry 206 detects fluid flow based on comparing pressure data from the inlet and the outlet. For example, if the pressure in the inlet is approximately equal to (e.g., within 3% of) the threshold pressure (e.g., the set pressure) and pressure in the outlet begins to change, fluid flow is detected through the pressure relief valve. In other examples, the flow detection circuitry 206 detects flow based on comparing changes in pressure data along the fluid flow path. In other words, the flow detection circuitry 206 compares how pressure data changes over time in the vessel, the inlet, the outlet, and/or the relief header to determine that fluid is flowing through the PRV. If fluid flow is not detected in the PRV, the operations 308 move to block 614, where the relief event is ended. Ending the relief event indicates that the relief event is over, and data collected during the relief event can be associated with the relief event. If the relief event ended without flow being detected, the relief event is discarded, and no data is associated with the relief event. The operations continue to block 616, where the PRV is assigned a state of sealed by the flow detection circuitry 206 and the report generating circuitry 208 to indicate no fluid is flowing through the PRV, and the operations 306 return to the operations 300 of FIG. 3.

Returning to block 602 of FIG. 6, if fluid flow is detected through the PRV, the operations 308 continue to block 604, where the flow detection circuitry 206 determines if the inlet pressure is greater than (e.g., more than 3% higher than) the set pressure (e.g., the threshold pressure value to open the PRV). If the inlet pressure is below the set pressure, the operations 308 continue to block 606, where the relief event is labeled as a leak by the flow detection circuitry 206 and the report generating circuitry 208. A leak indicates that fluid is flowing through the PRV because of a malfunction in the PRV (e.g., a degraded seal at the valve seat, damage to the PRV, a valve leak, etc.), not because the PRV opened to relieve excess pressure. After labeling the relief event as a leak, the operations 308 continue to block 608 where the flow detection circuitry 206 estimates a fluid flow rate based on a pressure differential between inlet and the outlet. In some examples, the flow detection circuitry 206 uses data pertaining to the PRV (e.g., orifice size, valve lift properties, etc.) to estimate a volumetric fluid release rate. The operations 308 continue to block 610, where the flow detection circuitry 206 calculates a volume of fluid relieved based on the fluid flow rate. In some examples, the volume of fluid relieved is calculated as a flow rate (e.g., an average flow rate) over a discrete amount of time (e.g., 100 milliseconds, 5 milliseconds, 1 second, etc.). The operations 308 continue to block 612, where the calculated volume of fluid is added to a cumulative fluid release volume correlated to the relief event. In this way, the volume of fluid moving through the PRV is tracked through the duration of the relief event. The operations 308 move to block 602, where the flow detection circuitry 206 continues to monitor the PRV for fluid flow within the PRV.

Returning to block 604 of FIG. 6, if the inlet pressure is not greater than the set pressure, the operations 308 move to block 608. In this way, the relief event is considered a standard relief event and is not labeled as a leak. At block 608, the flow detection circuitry 206 estimates a fluid flow rate based on a pressure differential between inlet and the outlet. The operations 308 continue to block 610, where the flow detection circuitry 206 calculates a volume of fluid relieved based on the flow rate. The operations 308 continue to block 612, where the calculated volume of fluid is added to a cumulative fluid release volume correlated to the relief event. The operations 308 move to block 602, where the flow detection circuitry 206 continues to monitor the PRV for fluid flow within the PRV. In this way, the flow detection circuitry 206 tracks a relief event and the volume of fluid released from when flow starts through the PRV until flow ends through the PRV. If fluid flow is no longer detected through the PRV at block 602, the operations 308 move to block 614 where the relief event is ended. In the examples where the relief event is ended after a fluid is released (e.g., the volume of fluid released is above a threshold), ending the relief event includes the flow detection circuitry 206 storing data correlated to the relief event in the database 210. The operations 308 continue to block 616 where the PRV is assigned a state of sealed by the flow detection circuitry 206 and the report generating circuitry 208, and the operations 308 return to the operations 300 of FIG. 3.

FIG. 7 is a block diagram of an example programmable circuitry platform 700 structured to execute and/or instantiate the example machine-readable instructions and/or the example operations of FIGS. 3, 4, 5, and/or 6 to implement the controller 102 of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the example pressure data receiving circuitry 202, the example valve state determining circuitry 204, the example flow detection circuitry 206, the example report generating circuitry 208, and the example database 210.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 3, 4, 5, and/or 6, may be stored in the mass storage device 728, in the volatile memory 714, in the non-volatile memory 716, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third. ” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that detect obstructed or otherwise blocked valves in pressure relief systems. Disclosed systems, apparatus, articles of manufacture, and methods improve pressure relief valves, and, more broadly, pressure relief systems by monitoring system pressures and detecting blocked, obstructed, or otherwise malfunctioning pressure relief valves. Thus, users are alerted to valve states that can prevent or otherwise hinder a pressure relief valve from relieving excessive pressure from a pressurized fluid system. In particular, disclosed systems, apparatus, articles of manufacture, and methods enable remotely detecting a state of manually actuated valves, such as isolation valves, which would otherwise be difficult to inspect. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to detect obstructed valves in pressure relief systems are disclosed herein. Further examples and combinations thereof include the following:

Example 1 includes 1 includes a fluid system comprising a vessel to contain a fluid, the vessel including a first pressure sensor to measure a first pressure of fluid within the vessel, a pressure relief valve coupled to the vessel via a first isolation valve, the pressure relief valve including an inlet and an outlet, the first isolation valve to control a flow of fluid between the inlet and the vessel, a second pressure sensor to measure a second pressure of fluid in the inlet, a third pressure sensor to measure a third pressure of fluid in the outlet, the pressure relief valve to selectively fluidly couple or fluidly isolate the inlet and the outlet based on a comparison of the second pressure of fluid in the inlet to a threshold value, and a computing device including machine readable instructions and programmable circuitry. The computing device to at least one of instantiate or execute the machine readable instructions to receive pressure data associated with the measured pressures, determine a state of the fluid system based on the pressure data, and generate an indication corresponding to the state of the fluid system.

Example 2 includes the system of example 1, wherein determining the state of the fluid system includes determining a state of the first isolation valve and generating the indication includes generating an indication corresponding to the state of the first isolation valve, the state of the first isolation valve being open, closed, or obstructed.

Example 3 includes the system of example 1, further including a relief header coupled to the outlet of the pressure relief valve via a second isolation valve, the second isolation valve to control a flow of fluid between the outlet to the relief header, the relief header to receive fluid from the outlet, the relief header including a fourth pressure sensor to measure a fourth pressure of fluid in the relief header.

Example 4 includes the system of example 3, wherein determining the state of the fluid system includes determining a state of the second isolation valve and generating the indication includes generating an indication corresponding to the state of the second isolation valve, the state of the second isolation valve being open, closed, obstructed, or undetermined.

Example 5 includes the system of example 1, wherein determining the state of the fluid system includes determining if the pressure relief valve has fluidly coupled the inlet to the outlet based on the pressure data and generating the indication includes generating an indication corresponding to a fluid coupling of the inlet and the outlet.

Example 6 includes the system of example 5, wherein generating the indication corresponding to a fluid coupling of the inlet and the outlet includes determining if the coupling corresponds to a valve leak.

Example 7 includes the system of example 5, wherein the computing device is further configured to estimate a volume of fluid moving through the pressure relief valve.

Example 8 includes the system of example 1, wherein the third pressure of fluid is a differential pressure between the inlet and the outlet.

Example 9 includes a pressure relief valve comprising an inlet port to be selectively fluidly coupled to a pressure vessel via a first shutoff valve, an exhaust port fluidly coupled to the inlet port via a valve, the valve to fluidly couple the inlet port and the exhaust port while a fluid pressure within the inlet port exceeds a threshold value, a first pressure sensor to detect a fluid pressure within the inlet port, a second pressure sensor to detect a differential fluid pressure between the exhaust port and the inlet port, and a data transmitter to transmit pressure data associated with the fluid pressures detected by the pressure sensors to a computing device.

Example 10 includes the pressure relief valve of example 9, wherein the first pressure sensor, the second pressure sensor, and the data transmitter are disposed in a housing separate from the inlet port, the exhaust port, and the valve.

Example 11 includes the pressure relief valve of example 10, wherein the first pressure sensor is fluidly coupled to the inlet port via a first pipe, and the second pressure sensor is fluidly coupled to the exhaust port via a second pipe.

Example 12 includes a non-transitory machine readable storage medium comprising instructions to cause programmable circuitry to at least obtain first pressure data from a vessel, obtain second pressure data from an inlet of a pressure relief valve, the pressure relief valve coupled to the vessel via a first isolation valve such that fluid flows from the vessel to the pressure relief valve when the first isolation valve is in an open position, obtain third pressure data from an outlet of the pressure relief valve, the outlet of the pressure relief valve coupled to the inlet of the pressure relief valve such that fluid flows from the inlet to the outlet when a pressure in the inlet exceeds a threshold pressure, and determine a state of one of the valves based on the pressure data.

Example 13 includes the non-transitory machine readable storage medium of example 12, wherein the one of the valves is the first isolation valve and the instructions cause the programmable circuitry to record the state of the first isolation valve.

Example 14 includes the non-transitory machine readable storage medium of example 12, wherein the instructions cause the programmable circuitry to obtain fourth pressure data from a second vessel, the second vessel coupled to the outlet of the pressure relief valve via a second isolation valve such that fluid flows from the outlet to the second vessel when the second isolation valve is open.

Example 15 includes the non-transitory machine readable storage medium of example 14, wherein the one of the valves is the second isolation valve and the instructions further cause the programmable circuitry to record the state of the second isolation valve.

Example 16 includes the non-transitory machine readable storage medium of example 13, wherein the state of the first isolation valve is one of closed, open, or partially closed.

Example 17 includes the non-transitory machine readable storage medium of example 14, wherein the instructions further cause the programmable circuitry to determine if fluid is flowing from the inlet to the outlet based on the pressure data.

Example 18 includes the non-transitory machine readable storage medium of example 17, wherein determining if fluid is flowing from the inlet to the outlet includes estimating a flow rate of the fluid.

Example 19 includes the non-transitory machine readable storage medium of example 18, wherein the instructions further cause the programmable circuitry to record an estimated volume of fluid that has flowed from the inlet to the outlet.

Example 20 includes the non-transitory machine readable storage medium of example 18, wherein determining if fluid is flowing from the inlet to the outlet includes determining if the fluid flow is indicative of a leak.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A fluid system comprising:
a vessel to contain a fluid, the vessel including a first pressure sensor to measure a first pressure of fluid within the vessel;
a pressure relief valve coupled to the vessel via a first isolation valve, the pressure relief valve including an inlet and an outlet, the first isolation valve to control a flow of fluid between the inlet and the vessel;
a second pressure sensor to measure a second pressure of fluid in the inlet;
a third pressure sensor to measure a third pressure of fluid in the outlet, the pressure relief valve to selectively fluidly couple or fluidly isolate the inlet and the outlet based on a comparison of the second pressure of fluid in the inlet to a threshold value; and
a computing device configured to:
receive pressure data associated with the measured pressures;
determine a state of the fluid system based on the pressure data; and
generate an indication corresponding to the state of the fluid system.

2. The system of claim 1, wherein determining the state of the fluid system includes determining a state of the first isolation valve and generating the indication includes generating an indication corresponding to the state of the first isolation valve, the state of the first isolation valve being open, closed, or obstructed.

3. The system of claim 1, further including a relief header coupled to the outlet of the pressure relief valve via a second isolation valve, the second isolation valve to control a flow of fluid between the outlet to the relief header, the relief header to receive fluid from the outlet, the relief header including a fourth pressure sensor to measure a fourth pressure of fluid in the relief header.

4. The system of claim 3, wherein determining the state of the fluid system includes determining a state of the second isolation valve and generating the indication includes generating an indication corresponding to the state of the second isolation valve, the state of the second isolation valve being open, closed, obstructed, or undetermined.

5. The system of claim 1, wherein determining the state of the fluid system includes determining if the pressure relief valve has fluidly coupled the inlet to the outlet based on the pressure data and generating the indication includes generating an indication corresponding to a fluid coupling of the inlet and the outlet.

6. The system of claim 5, wherein generating the indication corresponding to a fluid coupling of the inlet and the outlet includes determining if the coupling corresponds to a valve leak.

7. The system of claim 5, wherein the computing device is further configured to estimate a volume of fluid moving through the pressure relief valve.

8. The system of claim 1, wherein the third pressure of fluid is a differential pressure between the inlet and the outlet.

9. A pressure relief valve comprising:
an inlet port to be selectively fluidly coupled to a pressure vessel via a first shutoff valve;
an exhaust port fluidly coupled to the inlet port via a valve, the valve to fluidly couple the inlet port and the exhaust port while a fluid pressure within the inlet port exceeds a threshold value;
a first pressure sensor to detect a fluid pressure within the inlet port;
a second pressure sensor to detect a differential fluid pressure between the exhaust port and the inlet port; and
a data transmitter to transmit pressure data associated with the fluid pressures detected by the pressure sensors to a computing device.

10. The pressure relief valve of claim 9, wherein the first pressure sensor, the second pressure sensor, and the data transmitter are disposed in a housing separate from the inlet port, the exhaust port, and the valve.

11. The pressure relief valve of claim 10, wherein the first pressure sensor is fluidly coupled to the inlet port via a first pipe, and the second pressure sensor is fluidly coupled to the exhaust port via a second pipe.

12. A non-transitory machine readable storage medium comprising instructions to cause programmable circuitry to at least:
obtain first pressure data from a vessel;
obtain second pressure data from an inlet of a pressure relief valve, the pressure relief valve coupled to the vessel via a first isolation valve such that fluid flows from the vessel to the pressure relief valve when the first isolation valve is in an open position;
obtain third pressure data from an outlet of the pressure relief valve, the outlet of the pressure relief valve coupled to the inlet of the pressure relief valve such that fluid flows from the inlet to the outlet when a pressure in the inlet exceeds a threshold pressure; and
determine a state of one of the valves based on the pressure data.

13. The non-transitory machine readable storage medium of claim 12, wherein the one of the valves is the first isolation valve and the instructions cause the programmable circuitry to record the state of the first isolation valve.

14. The non-transitory machine readable storage medium of claim 12, wherein the instructions cause the programmable circuitry to:
obtain fourth pressure data from a second vessel, the second vessel coupled to the outlet of the pressure relief valve via a second isolation valve such that fluid flows from the outlet to the second vessel when the second isolation valve is open.

15. The non-transitory machine readable storage medium of claim 14, wherein the one of the valves is the second isolation valve and the instructions further cause the programmable circuitry to record the state of the second isolation valve.

16. The non-transitory machine readable storage medium of claim 13, wherein the state of the first isolation valve is one of closed, open, or partially closed.

17. The non-transitory machine readable storage medium of claim 14, wherein the instructions further cause the programmable circuitry to determine if fluid is flowing from the inlet to the outlet based on the pressure data.

18. The non-transitory machine readable storage medium of claim 17, wherein determining if fluid is flowing from the inlet to the outlet includes estimating a flow rate of the fluid.

19. The non-transitory machine readable storage medium of claim 18, wherein the instructions further cause the programmable circuitry to record an estimated volume of fluid that has flowed from the inlet to the outlet.

20. The non-transitory machine readable storage medium of claim 18, wherein determining if fluid is flowing from the inlet to the outlet includes determining if the fluid flow is indicative of a leak.
